(19) United States
(12) Patent Application Publication
(10) Pub. No.: US 2004/0118241 A1
(43) Pub. Date: Jun. 24, 2004

(54) Arrangement, method, and system to reduce the play of micro-mechanical produced gears

(76) Inventors: Andreas Niendorf, Berlin (DE); Wilhelm Frey, Mountain View, CA (US); Zhiyu Pan, Mountain View, CA (US)

Correspondence Address: KENYON & KENYON, ONE BROADWAY, NEW YORK, NY, 10004, US

(21) Appl. No.: 10/324,911

(22) Filed: Dec. 20, 2002

(51) Int. Cl. F16H 33/00; F16H 35/00; F16H 37/00

(52) U.S. Cl. 74/640

(57) ABSTRACT

An apparatus is described to reduce a play occurring in a micro-mechanical gear arrangement, the apparatus having a moveable hub coupled to a gear of the micro-mechanical gear arrangement, the moveable hub configured to permit a movement of the gear that reduces the play. A push rod is coupled to the moveable hub and at least one buckling beam is tethered to the push rod so that a force is exerted upon the push rod to cause the movement of the gear, the force being transferable to the gear via the moveable hub.

### FIELD OF THE INVENTION

The present invention relates to an arrangement, method, and system to reduce or prevent the “play” movement occurring in micro-mechanically produced gears.

### BACKGROUND INFORMATION

Micro-mechanical gears may be produced by a lithographic batch process. This process may be used to fabricate an arbitrary amount of gears and gear trains in a single step. However, due to limitations of the process, there may be a certain minimum gap between the teeth of the gears, that may result in a free-movement or “play” of the gears. For example, when a gear train is manufactured, the gears may include one or more “sacrificial” fabrication layers between the gears that remain after assembly. If the sacrificial layer(s) between the gears are subsequently removed, a gap may be created between the gears. Although this gap may be small (such as, for example, one micron), it may nonetheless permit “free” rotation of the gears. Such “free” rotation may limit the overall precision of the gear train and hence may be undesirable.

### SUMMARY OF THE INVENTION

The present invention provides an arrangement, method, and system to reduce or prevent the “play” movement occurring in micro-mechanically produced gears.

The exemplary embodiments and/or exemplary method of the present invention is directed to an apparatus to reduce a play occurring in a micro-mechanical gear arrangement, the apparatus including a moveable hub coupled to a gear of the micro-mechanical gear arrangement, the moveable hub configured to permit a movement of the gear to reduce the play, the apparatus further including a push rod coupled to the moveable hub and at least one buckling beam tethered to the push rod and arranged to exert a force upon the push rod to cause the movement of the gear, the force being transferable to the gear via the moveable hub.

Yet another exemplary embodiment and/or exemplary method is directed to the apparatus in which the micro-mechanical gear arrangement includes a gear train.

Still another exemplary embodiment and/or exemplary method is directed to the apparatus further including a micro-mechanical mirror coupled to the gear train.

Yet another exemplary embodiment and/or exemplary method is directed to the apparatus further including a micro-mechanical pump coupled to the gear train.

Still another exemplary embodiment and/or exemplary method is directed to the apparatus further including a biological manipulator coupled to the gear train.

Yet another exemplary embodiment and/or exemplary method is directed to the apparatus in which a width of the moveable hub is at least 200 μm.

Still another exemplary embodiment and/or exemplary method is directed to the apparatus in which a width of the moveable hub is about 250 μm.

Yet another exemplary embodiment and/or exemplary method is directed to the apparatus in which a length of the at least one buckling beam is at least 50 μm.

Yet another exemplary embodiment and/or exemplary method is directed to the apparatus in which a width of the moveable hub is about 250 μm and a length of the at least one buckling beam is at least 50 μm.

Still another exemplary embodiment and/or exemplary method is directed to the apparatus in which a buckling of the at least one buckling beam results from a compressive stress of a fabricated micro-mechanical device layer.

Yet another exemplary embodiment and/or exemplary method is directed to the apparatus in which the at least one buckling beam has an initial slightly bended shape.

Still another exemplary embodiment and/or exemplary method is directed to the apparatus in which the at least one buckling beam has an initial slightly bended shape of about 1%.

Yet another exemplary embodiment and/or exemplary method is directed to the apparatus in which the at least one buckling beam includes two buckling beams arranged to suspend the push rod.

Still another exemplary embodiment and/or exemplary method is directed to a fabrication of a buckling beam in which a fixed-fixed beam is subjected to a compressive stress of a fabricated micro-mechanical device layer.

Yet another exemplary embodiment and/or exemplary method is directed to the fabrication of the buckling beam in which an initial slightly bended shape is provided to the fixed-fixed beam.

Still another exemplary embodiment and/or exemplary method is directed to reducing a play occurring in micro-mechanical gear arrangement in which a moveable hub is coupled to a gear of the micro-mechanical gear arrangement, the moveable hub is operable to permit a movement of the gear to reduce the play, a push rod is coupled to the moveable hub, and at least one buckling beam is attached to the push rod so that a force is exerted on the push rod that causes the movement of the gear to reduce the play.

Yet another exemplary embodiment and/or exemplary method is directed to coupling a moveable rack with the micro-mechanical gear arrangement.

Still another exemplary embodiment and/or exemplary method is directed to an apparatus to reduce a play occurring in a micro-mechanically produced gear train, the apparatus including a moveable rack and at least one buckling beam tethered to the moveable rack and arranged to exert a force upon the moveable rack to cause a movement of the rack to reduce the play.

Yet another exemplary embodiment and/or exemplary method is directed to the apparatus in which a width of the moveable rack is about 120 μm.

Yet another exemplary embodiment and/or exemplary method is directed to the apparatus in which a width of the moveable rack is about 120 μm and the at least one buckling beam includes two buckling beams tethered to opposite ends of the moveable rack.

Still another exemplary embodiment and/or exemplary method is directed to the apparatus in which the at least one buckling beam includes two buckling beams tethered to opposite ends of the moveable rack.

Yet another exemplary embodiment and/or exemplary method is directed to the apparatus including a micro-mechanical comb drive to supply an electro-static force upon the moveable rack.

Still another exemplary embodiment and/or exemplary method is directed to a micro-mechanical gear apparatus having a reduced play, the micro-mechanical gear apparatus including a gear, a moveable hub coupled to the gear and configured to permit a movement of the gear to result in the reduced play, a push rod coupled to the moveable hub, and at least one buckling beam tethered to the push rod and arranged to exert a force upon the push rod to cause the movement of the gear, the force being transferable to the gear via the moveable hub.

### BRIEF DESCRIPTION OF THE DRAWINGS

FIG. 1a shows a micro-mechanical geartrain with play.

FIG. 1b shows a side view of the micro-mechanical geartrain of FIG. 1a along axis A-A.

FIG. 1c shows the micro-mechanical gear train of FIG. 1a with a micro-mechanical arrangement to reduce or eliminate the play.

FIG. 1d shows a side view of the micro-mechanical gear train and arrangement of FIG. 1c along axis B-B.

FIG. 1e shows the micro-mechanical gear train of FIG. 1a with a push rod/buckling beam arrangement to reduce or eliminate the play.

FIG. 2a shows a deflection of a fixed-fixed beam due to a compressive stress of a fabricated MEMS device layer.

FIG. 2b shows a deflection of a single-fixed beam within a fabricated MEMS device layer.

FIG. 3a shows a push rod/buckling beam arrangement to reduce or eliminate play between a gear and a rack of a micro-mechanical gear/rod combination arrangement.

FIG. 3b shows a rack-suspended/buckling beam arrangement to reduce or eliminate the play between gear and a moveable rack of a micro-mechanical gear/rod combination arrangement.

### DETAILED DESCRIPTION

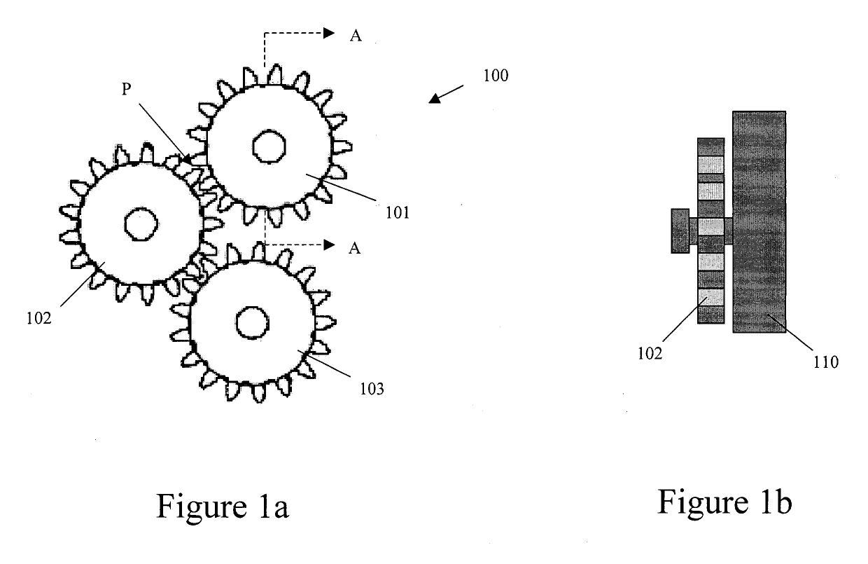

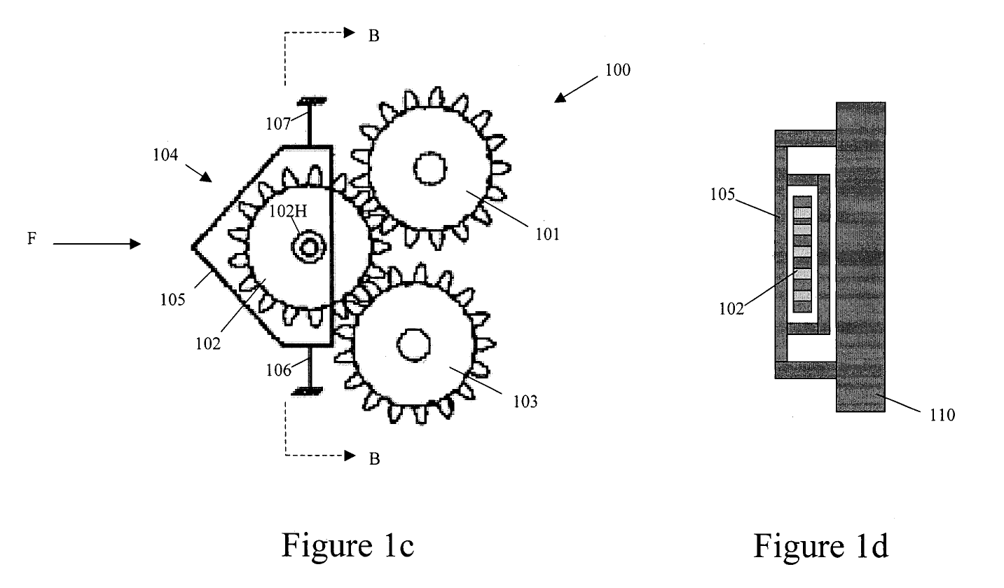

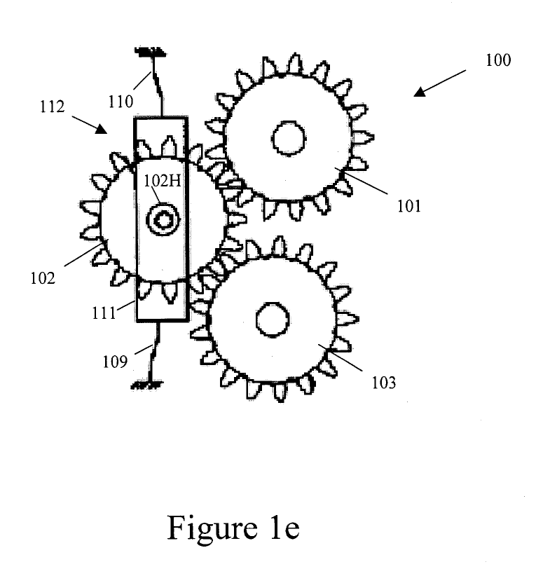

FIG. 1a shows a micro-mechanical geartrain 100 with a play “P” and FIG. 1b shows a side view of the micro-mechanical geartrain 100 along axis A-A. The micro-mechanical gear train 100 includes micro-mechanical gears 101, 102, and 103 upon a substrate 110 in an initial position of engagement after their fabrication and release. In particular, the micro-mechanical gear 101 is engaged with the gear 102, which is also engaged with the gear 103.

Due to the manufacturing process, for example, the play P may occur between the gear 101 and the gear 102 and/or between the gear 102 and the gear 103. In particular, the manufacturing process may require a “sacrificial” layer of approximately 1 μm, for example, to be applied and then removed, thereby leaving a gap between the gears. The play P, if left unreconciled or uncorrected, may result in several problems. For example, if the gear 101 is a driving gear, it may need to turn several degrees to compensate for the play P before the gear 103 may start to turn. Thus, if the gear 101 initiates a movement or a change in direction of rotation, the gear 103 may respond sluggishly, which may be undesirable. For example, if a micro-mirror is attached to the gear 103, a precise reflection angle may not be achievable.

FIG. 1c shows the micro-mechanical gear train 100 of FIG. 1a with a micro-mechanical arrangement 104 to reduce or eliminate the play P occurring between the gear 101 and the gear 102 and/or between the gear 102 and the gear 103. FIG. 1d shows a side view of the micro-mechanical arrangement 104 along axis B-B. The micro-mechanical arrangement 104 includes a push rod 105, a moveable hub 102H, a micro-mechanical beam 106, and a micro-mechanical beam 107. In particular, the push rod 105 is coupled to the moveable hub 102H and tethered by the two micro-mechanical beams 106, 107. The moveable hub 102H is further coupled to the gear 102.

To reduce the play P occurring between the gear 101 and the gear 102, the micro-mechanical arrangement 104 presses the gear 102 against the other two gears 101 and 103. More specifically, a force F (generated, for example, by an electrostatic drive) is applied to the push rod 105 that transfers the force F to the moveable hub 102H, which moves the gear 102 closer to the gears 101 and 103, thereby reducing or preventing play P from occurring between the gear 102 and the gear 101 and/or between the gear 102 and the gear 103.

The micro-mechanical arrangement 104 may be realized, for example, in a MEMS process with 2 moveable structural layers. According to one exemplary embodiment, if the diameter of the gear 102 is 100 μm, then the width of hub 102H should be at least 200 μm to ensure a proper functioning. A width of 250 μm, for example, may be sufficient. Furthermore, the micro-mechanical beams 106 and 107 should extend at least 50 μm, for example, to achieve enough compressive stress. However, such a micro-mechanical actuator arrangement 104 may require additional space and electronics to accommodate the actuator.

FIG. 1e shows the micro-mechanical gear train 100 of FIG. 1a with a push rod/buckling beam arrangement 112 to reduce or eliminate the play “P” between the gear 101 and the gear 102 and/or between the gear 102 and the gear 103. The push rod/buckling beam arrangement 112 includes a push rod 111, the moveable hub 102H, and two buckling beams 109 and 110. In particular, the push rod 111 is coupled to the moveable hub 102H and tethered by the two buckling beams 109, 110. The moveable hub 102h is further coupled to the gear 102.

The buckling action of the buckling beams 109, 110 exerts a force on the push rod 111 that is transferred to the moveable hub 102H, which causes the gear 102 to be pressed against the gear 101 and the gear 103. This eliminates or at least reduces the play P between the gear 102 and the gear 101 and/or between the gear 102 and the gear 103. The push rod/buckling beam arrangement 112 of FIG. 1e may require less space and less energy as compared with the micro-mechanical actuator arrangement 104 of FIG. 1c.

The buckling action of the buckling beams 109, 110 results from compressive stresses within the MEMS fabricated device layer. The layers used to fabricate MEMS devices may possess small, but appreciable, intrinsic stress. In case of a compressive stress, the released layer or “thin film” may expand. Consequently, a fixed-fixed-beam within this layer may start to buckle.

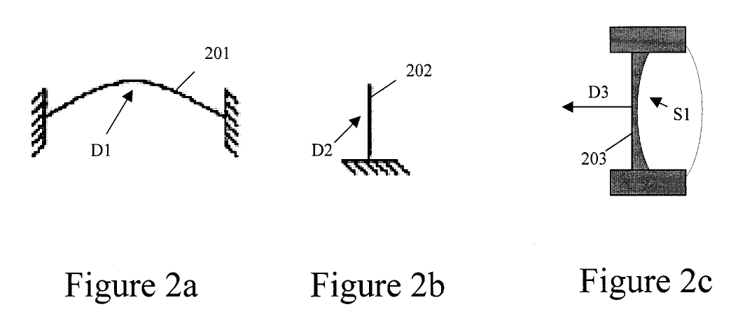

FIG. 2a shows a deflection D1 of a fixed-fixed beam 201 due to a compressive stress of a fabricated MEMS device layer. FIG. 2b shows a deflection D2 of a single-fixed beam 202 within the same fabricated device layer. As shown in FIGS. 2a and 2b, the deflection D1 of the fixed-fixed beam 201 is greater than the deflection D2 of the single-fixed beam 202 whose free end may expand unaffected by the compressive stress. The greater deflection D1 may be used to exert an internal force upon moveable structures within the micro-mechanical device. The internal force may act upon, for example, a micro-mechanical gear within a micro-mechanical geartrain (such as, for example, the gear 102 of the geartrain 100 shown in FIGS. 1a-1e) thereby eliminating or at least reducing the play occurring between the gears which may have been created, for example, during fabrication of the MEMS device.

FIG. 2c shows an alternative view of a fixed-fixed beam 203. To define the direction of the deflection D3, the fixed-fixed beam 203 receives an initial slightly bended shape S1. The initial slightly bended shape S1 may be configurable to as little as 1%, for example. Hence, arranging one or more fixed-fixed beams having an initial slightly bended shape within a micro-mechanical device may provide a predetermined directional movement of attached structures, as demonstrated by the push rod/buckling arrangement 112 of FIG. 1e.

In addition to micro-mechanical gears and gear trains, the push rod/buckling beam arrangement 112 may be applied to micro-mechanical gear rod combinations as well.

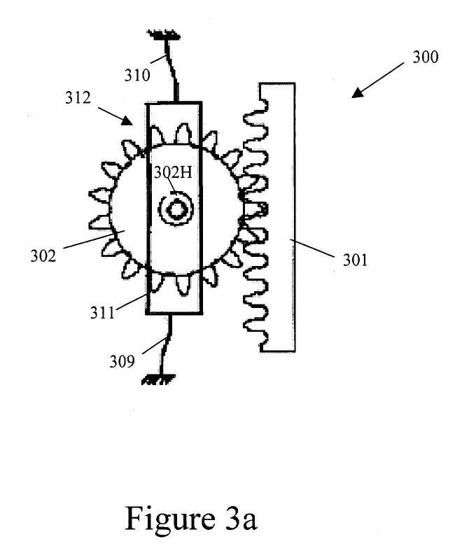

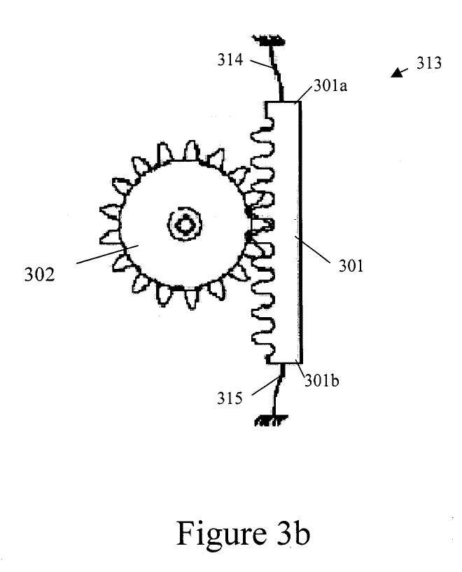

FIG. 3a shows a push rod/buckling beam arrangement 312 to reduce or eliminate the play P between a gear 302 and a rack 301 of a micro-mechanical gear/rod combination arrangement 300. The push rod/buckling beam arrangement 312 includes a push rod 311, a moveable hub 302H, and two buckling beams 309 and 310. In particular, the push rod 311 is coupled to the moveable hub 302H and tethered by the buckling beams 309, 310. The moveable hub 302H is further coupled to the gear 302.

The buckling action of the buckling beams 309, 310 exerts a force on the push rod 311 that is transferred to the moveable hub 302H, which causes gear 302 to be pressed against gear 301 thereby eliminating or at least reducing the play P occurring between the gear 302 and the rack 301. The push rod/buckling beam arrangement 312 may require less space and less energy than other micro-mechanical arrangements. According to one exemplary embodiment, the rack 301 may be approximately 120 μm in width, for example, to accommodate gears on the order of 100 μm in diameter.

As an alternative to FIG. 3a, FIG. 3b shows a rack-suspended/buckling beam arrangement 313 to reduce or eliminate the play P between the gear 302 and a moveable rack 301 of a micro-mechanical gear/rod combination arrangement 300. The rack-suspended/buckling beam arrangement 313 includes two buckling beams 314, 315 attached to two ends 301a, 301b of the moveable rack 301. In particular, the buckling beam 314 is attached to an end 301a and the buckling beam 315 is attached to another end 301b. According to another exemplary embodiment, the moveable rack 301 may be connected to another structure, such as, for example, a micro-mechanical comb driven by an electro-static force.

The arrangements described herein may be applied to many driving mechanisms for many kind of MEMS applications, such as, for example, micro-mechanical mirrors, pumps, biological manipulators, etc.

What is claimed is:

1. An apparatus to reduce a play occurring in a micro-mechanical gear arrangement, the apparatus comprising:
a moveable hub coupled to a gear of the micro-mechanical gear arrangement, the moveable hub configured to permit a movement of the gear to reduce the play;
a push rod coupled to the moveable hub; and
at least one buckling beam tethered to the push rod and arranged to exert a force upon the push rod to cause the movement of the gear, the force being transferable to the gear via the moveable hub.

2. The apparatus of claim 1, wherein the micro-mechanical gear arrangement includes a gear train.

3. The apparatus of claim 2, further comprising:
a micro-mechanical mirror coupled to the gear train.

4. The apparatus of claim 2, further comprising:
a micro-mechanical pump coupled to the gear train.

5. The apparatus of claim 2, further comprising:
a biological manipulator coupled to the gear train.

6. The apparatus of claim 1, wherein a width of the moveable hub is at least 200 μm.

7. The apparatus of claim 1, wherein a width of the moveable hub is about 250 μm.

8. The apparatus of claim 1, wherein a length of the at least one buckling beam is at least 50 μm.

9. The apparatus of claim 1, wherein a width of the moveable hub is about 250 μm and a length of the at least one buckling beam is at least 50 μm.

10. The apparatus of claim 1, wherein a buckling of the at least one buckling beam results from a compressive stress of a fabricated micro-mechanical device layer.

11. The apparatus of claim 1, wherein the at least one buckling beam has an initial slightly bended shape.

12. The apparatus of claim 1, wherein the at least one buckling beam has an initial slightly bended shape of about 1%.

13. The apparatus of claim 1, wherein the at least one buckling beam includes two buckling beams arranged to suspend the push rod.

14. A method of fabricating a buckling beam, comprising:
subjecting a fixed-fixed beam to a compressive stress of a fabricated micro-mechanical device layer.

15. The method of claim 14, further comprising:
providing an initial slightly bended shape to the fixed-fixed beam.

16. A method of reducing a play occurring in micro-mechanical gear arrangement, comprising:
coupling a moveable hub to a gear of the micro-mechanical gear arrangement, wherein the moveable hub is operable to permit a movement of the gear to reduce the play;
coupling a push rod to the moveable hub; and
attaching at least one buckling beam to the push rod so that a force is exerted on the push rod that causes the movement of the gear to reduce the play.

17. The method of claim 16, further comprising:
coupling a moveable rack with the micro-mechanical gear arrangement.

18. An apparatus to reduce a play occurring in a micro-mechanically produced gear train, the apparatus comprising:
a moveable rack; and
at least one buckling beam tethered to the moveable rack and arranged to exert a force upon the moveable rack to cause a movement of the rack to reduce the play.

19. The apparatus of claim 18, wherein a width of the moveable rack is about 120 μm.

20. The apparatus of claim 18, wherein the at least one buckling beam includes two buckling beams tethered to opposite ends of the moveable rack.

21. The apparatus of claim 18, wherein a width of the moveable rack is about 120 μm and the at least one buckling beam includes two buckling beams tethered to opposite ends of the moveable rack.

22. The apparatus of claim 18, further comprising:
a micro-mechanical comb drive to supply an electro-static force upon the moveable rack.

23. A micro-mechanical gear apparatus having a reduced play, comprising:
a gear;
a moveable hub coupled to the gear and configured to permit a movement of the gear to result in the reduced play;
a push rod coupled to the moveable hub; and
at least one buckling beam tethered to the push rod and arranged to exert a force upon the push rod to cause the movement of the gear, the force being transferable to the gear via the moveable hub.
